(19) United States
(12) Patent Application Publication
(10) Pub. No.: US 2013/0270043 A1
(43) Pub. Date: Oct. 17, 2013

(54) ELEVATOR SYSTEM BELT

(71) Applicants: John P. Wesson, Vernon, CT (US); Gopal R. Krishnan, Wethersfield, CT (US); Huan Zhang, Glastonbury, CT (US); Timothy Devalve, Manchester, CT (US); David Wayne McKee, Somers, CT (US)

(72) Inventors: John P. Wesson, Vernon, CT (US); Gopal R. Krishnan, Wethersfield, CT (US); Huan Zhang, Glastonbury, CT (US); Timothy Devalve, Manchester, CT (US); David Wayne McKee, Somers, CT (US)

(73) Assignee: OTIS ELEVATOR COMPANY, Farmington, CT (US)

(21) Appl. No.: 13/992,562

(22) PCT Filed: Dec. 22, 2010
(86) PCT No.: PCT/US2010/061825

§ 371 Date: Jun. 7, 2013

(51) Int. Cl. B66B 11/00

(52) U.S. Cl. CPC B66B 11/0065
USPC 187/251; 428/375

(57) ABSTRACT

A belt for suspending and/or driving an elevator car includes a plurality of wires arranged into one or more cords and a jacket substantially retaining the one or more cords. Each cord includes a plurality of wires arranged around at least one non load-bearing core. An elevator system includes an elevator car and one or more sheaves. One or more belts are operably connected to the car and interactive with the one or more sheaves for suspending and/or driving the elevator car. Each belt of the one or more belts includes a plurality of wires arranged into one or more cords and a jacket substantially retaining the one or more cords. Each cord includes a plurality of wires arranged around at least one non load-bearing core.

### BACKGROUND OF THE INVENTION

The subject matter disclosed herein relates to elevator systems. More specifically, the subject disclosure relates to tension members for elevator suspension and/or driving.

Elevator systems utilize a lifting means, such as ropes or belts operably connected to an elevator car, and routed over one or more sheaves, also known as pulleys, to propel the elevator along a hoistway. Lifting belts in particular typically include a plurality of wires at least partially within a jacket material. The plurality of wires are often arranged into one or more strands and the strands are then arranged into one or more cords.

Wire arrangements are typically designed with at least two basic requirements in mind, breaking strength and cord life. The total cross-sectional area of steel used in the cord is the primary determinant of breaking strength of the cord. A large number of small cross-section wires are typically avoided for cost reasons and large cross-section wires would be expected to have a limited fatigue life thus limiting the overall life of the cord. Further, nearly equal wire cross-sectional areas are typically preferred, since the largest wire usually has the shortest fatigue life and becomes the limiting element when determining cord life.

Some arrangements utilize a number of outer wires arranged around a single center wire or group of wires. Depending on the size and number of center wires, however, only certain numbers of outer wires can be placed around the center wires in compact, geometrically stable (where the outer wires do not move relative to the center wires or each other) arrangements to guarantee a minimum breaking strength of the cord, while keeping the wire sizes equal or nearly equal. Further, in many such arrangements, the center wire or wires tend to operate at a disproportionate stress level during operation, limiting its life.

### BRIEF DESCRIPTION OF THE INVENTION

According to one aspect of the invention, a belt for suspending and/or driving an elevator car includes a plurality of wires arranged into one or more cords and a jacket substantially retaining the one or more cords. Each cord includes a plurality of wires arranged around at least one non load-bearing core.

Alternatively in this or other aspects of the invention, at least some of the plurality of wires are arranged in a plurality of strands, and the plurality of strands are arranged into the one or more cords.

Alternatively in this or other aspects of the invention, at least one of the plurality of strands includes the at least one non load-bearing core.

Alternatively in this or other aspects of the invention, all of the plurality of strands include the at least one non load-bearing core.

Alternatively in this or other aspects of the invention, the plurality of strands in at least one of the one or more cords include a plurality of outer strands arranged about one or more center strands.

Alternatively in this or other aspects of the invention, the one or more center strands include the at least one non load-bearing core.

Alternatively in this or other aspects of the invention, the at least one non load-bearing core is formed from an elastomeric material.

Alternatively in this or other aspects of the invention, the at least one non load-bearing core is a single unitary element.

Alternatively in this or other aspects of the invention, the at least one non load-bearing core is a plurality of elements.

Alternatively in this or other aspects of the invention, the plurality of wires in the one or more cords are arranged in a geometrically stable arrangement.

Alternatively in this or other aspects of the invention, at least one of the one or more cords includes the at least one non load-bearing core surrounded by an inner ring of wires surrounded by an outer ring of wires.

According to another aspect of the invention, an elevator system includes an elevator car and one or more sheaves. One or more belts are operably connected to the car and interactive with the one or more sheaves for suspending and/or driving the elevator car. Each belt of the one or more belts includes a plurality of wires arranged into one or more cords and a jacket substantially retaining the one or more cords. Each cord includes a plurality of wires arranged around at least one non load-bearing core.

Alternatively in this or other aspects of the invention, at least some of the plurality of wires are arranged in a plurality of strands, and the plurality of strands are arranged into the one or more cords.

Alternatively in this or other aspects of the invention, at least one of the plurality of strands includes the at least one non load-bearing core.

Alternatively in this or other aspects of the invention, all of the plurality of strands include the at least one non load-bearing core.

Alternatively in this or other aspects of the invention, the plurality of strands in at least one of the one or more cords include a plurality of outer strands arranged about one or more center strands.

Alternatively in this or other aspects of the invention, the one or more center strands include the at least one non load-bearing core.

Alternatively in this or other aspects of the invention, the at least one non load-bearing core is formed from an elastomeric material.

Alternatively in this or other aspects of the invention, the at least one non load-bearing core is a single unitary element.

Alternatively in this or other aspects of the invention, the at least one non load-bearing core is a plurality of elements.

Alternatively in this or other aspects of the invention, the plurality of wires in the one or more cords are arranged in a geometrically stable arrangement.

Alternatively in this or other aspects of the invention, at least one of the one or more cords includes the at least one non load-bearing core surrounded by an inner ring of wires surrounded by an outer ring of wires.

According to yet another aspect of the invention, a cord for use in an elevator suspending and/or driving belt includes at least one non load-bearing core and a plurality of wires arranged around the non load-bearing core.

Alternatively in this or other aspects of the invention, at least some of the plurality of wires are arranged in a plurality of strands.

Alternatively in this or other aspects of the invention, at least one of the plurality of strands includes the at least one non load-bearing core.

Alternatively in this or other aspects of the invention, all of the plurality of strands include the non load-bearing core.

Alternatively in this or other aspects of the invention, the plurality of strands include a plurality of outer strands arranged about one or more center strands.

Alternatively in this or other aspects of the invention, the one or more center strands include the at least one non load-bearing core.

Alternatively in this or other aspects of the invention, the at least one non load-bearing core is formed from an elastomeric material.

Alternatively in this or other aspects of the invention, the at least one non load-bearing core is a single unitary element.

Alternatively in this or other aspects of the invention, the at least one non load-bearing core is a plurality of elements.

Alternatively in this or other aspects of the invention, the plurality of wires are arranged in a geometrically stable arrangement.

Alternatively in this or other aspects of the invention, the plurality of wires include an inner ring of wires surrounding the at least one non load-bearing core, and an outer ring of wires surrounding the inner ring of wires.

### BRIEF DESCRIPTION OF THE DRAWINGS

FIG. 1A is a schematic of an exemplary elevator system having a 1:1 roping arrangement;

FIG. 1B is a schematic of another exemplary elevator system having a different roping arrangement;

FIG. 1C is a schematic of another exemplary elevator system having a cantilevered arrangement;

FIG. 2 is a cross-sectional view of an exemplary elevator belt;

FIG. 3 is a cross-sectional view of a prior art cord for an elevator belt;

FIG. 4 is a cross-sectional view of an embodiment of a cord for an elevator belt;

FIG. 5 is a cross-sectional view of another embodiment of a cord for an elevator belt;

FIG. 6 is a cross-sectional view of another embodiment of a cord for an elevator belt;

FIG. 7 is a cross-sectional view of another embodiment of a cord for an elevator belt;

FIG. 8 is a cross-sectional view of another embodiment of a cord for an elevator belt;

FIG. 9 is a cross-sectional view of another embodiment of a cord for an elevator belt;

FIG. 10 is a cross-sectional view of another embodiment of a cord for an elevator belt; and

FIG. 11 is a cross-sectional view of another embodiment of a cord for an elevator belt.

The detailed description explains the invention, together with advantages and features, by way of examples with reference to the drawings.

### DETAILED DESCRIPTION OF THE INVENTION

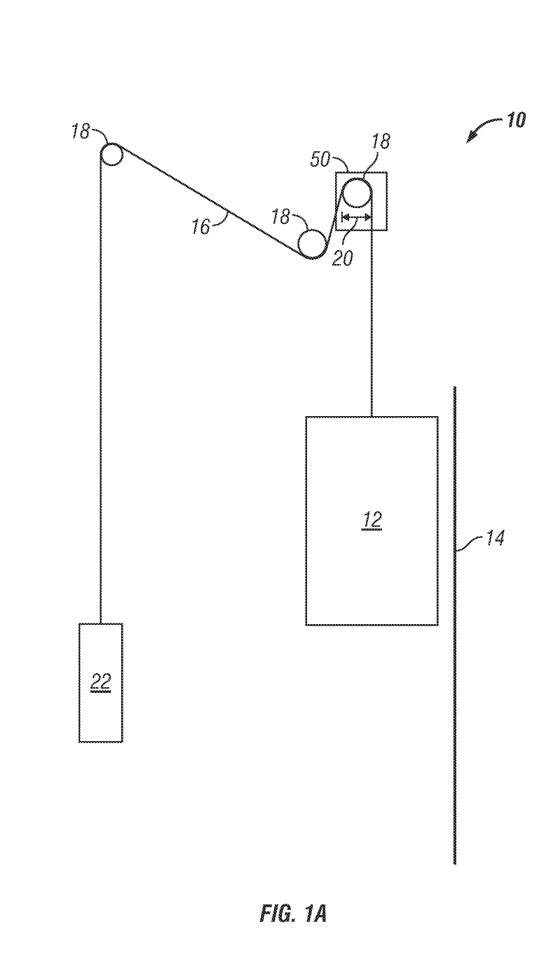

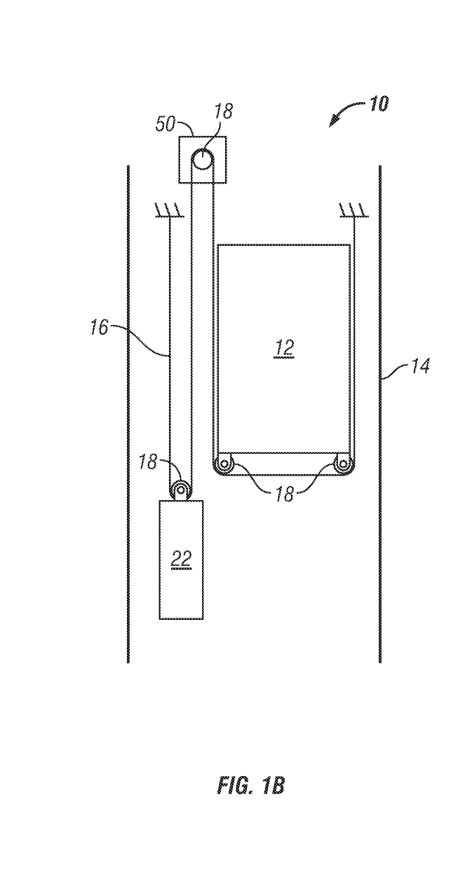

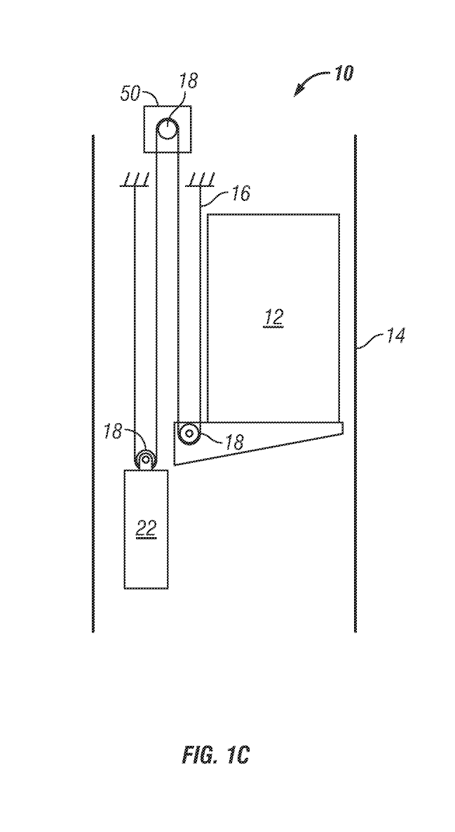

Shown in FIGS. 1A, 1B and 1C are schematics of exemplary traction elevator systems 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more belts 16. The one or more belts 16 interact with one or more sheaves 18 to be routed around various components of the elevator system 10. The one or more belts 16 could also be connected to a counterweight 22, which is used to help balance the elevator system 10 and reduce the difference in belt tension on both sides of the traction sheave during operation.

The sheaves 18 each have a diameter 20, which may be the same or different than the diameters of the other sheaves 18 in the elevator system 10. At least one of the sheaves 18 could be a drive sheave. A drive sheave is driven by a machine 50. Movement of drive sheave by the machine 50 drives, moves and/or propels (through traction) the one or more belts 16 that are routed around the drive sheave.

At least one of the sheaves 18 could be a diverter, deflector or idler sheave. Diverter, deflector or idler sheaves are not driven by a machine 50, but help guide the one or more belts 16 around the various components of the elevator system 10.

In some embodiments, the elevator system 10 could use two or more belts 16 for suspending and/or driving the elevator car 12. In addition, the elevator system 10 could have various configurations such that either both sides of the one or more belts 16 engage the one or more sheaves 18 (such as shown in the exemplary elevator systems in FIGS. 1A, 1B or 1C) or only one side of the one or more belts 16 engages the one or more sheaves 18.

FIG. 1A provides a 1:1 roping arrangement in which the one or more belts 16 terminate at the car 12 and counterweight 22. FIGS. 1B and 1C provide different roping arrangements. Specifically, FIGS. 1B and 1C show that the car 12 and/or the counterweight 22 can have one or more sheaves 18 thereon engaging the one or more belts 16 and the one or more belts 16 can terminate elsewhere, typically at a structure within the hoistway 14 (such as for a machineroomless elevator system) or within the machine room (for elevator systems utilizing a machine room. The number of sheaves 18 used in the arrangement determines the specific roping ratio (e.g. the 2:1 roping ratio shown in FIGS. 1B and 1C or a different ratio). FIG. 1C also provides a so-called rucksack or cantilevered type elevator. The present invention could be used on elevator systems other than the exemplary types shown in FIGS. 1A, 1B and 1C.

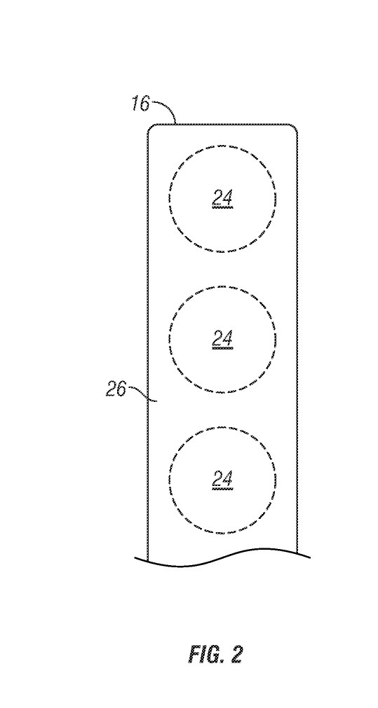

FIG. 2 provides a schematic of an exemplary belt construction or design. Each belt 16 is constructed of one or more cords 24 in a jacket 26. The cords 24 of the belt 16 could all be identical, or some or all of the cords 24 used in the belt 16 could be different than the other cords 24. For example, one or more of the cords 24 could have a different construction or size than the other cords 24. As seen in FIG. 2, the belt 16 has an aspect ratio greater than one (i.e. belt width is greater than belt thickness).

The belts 16 are constructed to have sufficient flexibility when passing over the one or more sheaves 18 to provide low bending stresses, meet belt life requirements and have smooth operation, while being sufficiently strong to be capable of meeting strength requirements for suspending and/or driving the elevator car 12.

The jacket 26 could be any suitable material, including a single material, multiple materials, two or more layers using the same or dissimilar materials, and/or a film. In one arrangement, the jacket 26 could be a polymer, such as an elastomer, applied to the cords 24 using, for example, an extrusion or a mold wheel process. In another arrangement, the jacket 26 could be a woven fabric that engages and/or integrates the cords 24. As an additional arrangement, the jacket 26 could be one or more of the previously mentioned alternatives in combination.

The jacket 26 can substantially retain the cords 24 therein. The phrase substantially retain means that the jacket 26 has sufficient engagement with the cords 24 such that the cords 24 do not pull out of, detach from, and/or cut through the jacket 26 during the application on the belt 16 of a load that can be encountered during use in an elevator system 10 with, potentially, an additional factor of safety. In other words, the cords 24 remain at their original positions relative to the jacket 26 during use in an elevator system 10. The jacket 26 could completely envelop the cords 24 (such as shown in FIG. 2), substantially envelop the cords 24, or at least partially envelop the cords 24

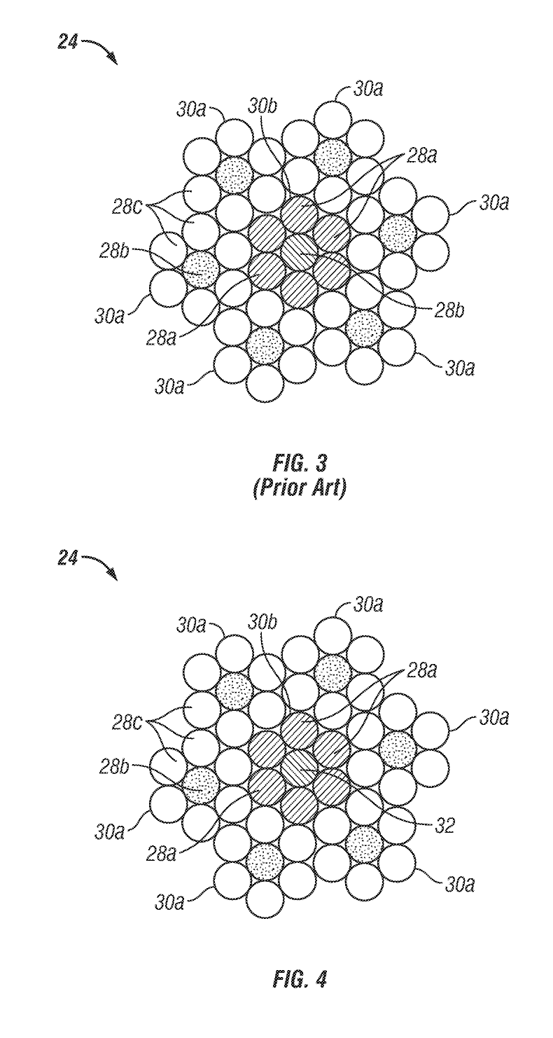

Referring now to FIG. 3, each cord 24 comprises a plurality of wires 28 in a geometrically stable arrangement. Optionally, some or all of these wires 28 could be formed into strands 30, which are then formed into the cord 24. The phrase geometrically stable arrangement means that the wires 28 (and if used, strands 30) generally remain at their theoretical positions in the cord 24. In other words, movement of the wires 28 (and if used, strands 30) relative to each other is limited. For example, relative movement of wire 28 could be limited to less than approximately thirty percent (30%) of its diameter. Relative movement of strand 30 could be limited to less than approximately five percent (5%) of its diameter.

Referring now to FIG. 4, an exemplary embodiment of a cord 24 includes six outer strands 30a arranged in a geometrically stable arrangement about a center strand 30b. While a single center strand 30b is shown in FIG. 4, it is to be appreciated that some embodiments of cords 24 may include more than one center strand 30b, for example, three center strands 30b around which the outer strands 30a are arranged. Each outer strand 30a includes six outer wires 28c arranged around a center wire 28b. The center strand 30b includes six outer wires 28a arranged around a core 32. The core 32 is non-load bearing in the tensile direction, and may be made of an elastomeric material or other material such as a natural or synthetic fiber. By non-load bearing, it is meant that the core 32 comprises less than approximately 5% of the total strength of the cord 24 and/or has a modulus of elasticity at least 10 times that of the modulus of elasticity of the wires 28.

The core 32 may be a single element as shown in FIG. 4, or alternatively may be a group of elements or a spun yarn. Further alternatively the core 32 may be formed of a thermoplastic material that could be configured to melt during fabrication of the belt 16 and penetrate the arrangement of outer wires 28a to promote adhesion when the cords 24 are incorporated into a belt 16. Further, in some embodiments, the core 32 and the wires 28 are configured such that the cord 24 is substantially of the same diameter as a conventional wire-only cord.

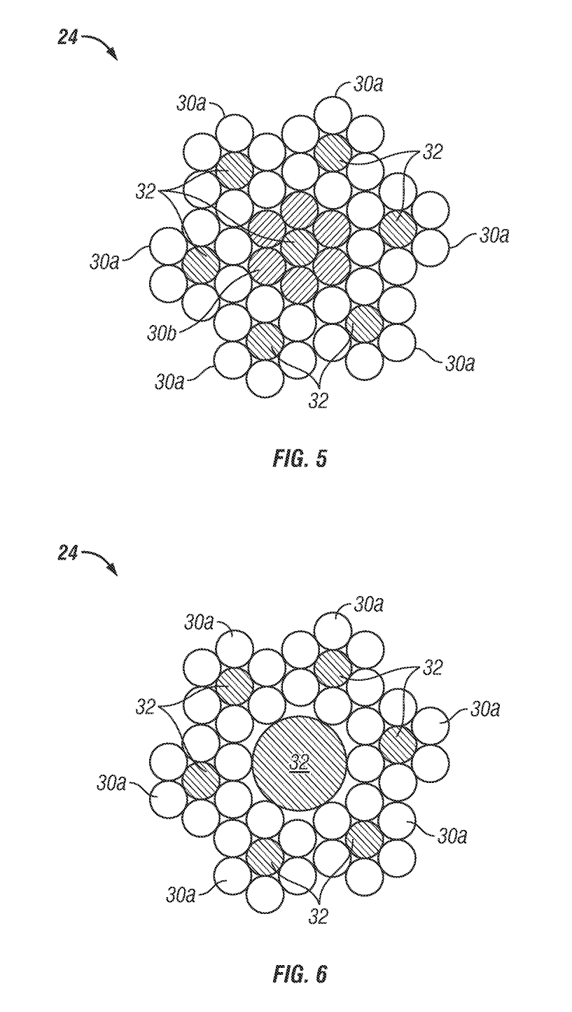

Referring now to FIG. 5, in some embodiments, the center wire 28b of FIG. 4 of one or more of the outer strands 30a may be replaced by a core 32. Further, referring to FIG. 6, in some embodiments, the center strand 30b of FIG. 4 may be entirely replaced by a core 32.

Utilizing the non load-bearing core 32 in the construction of the cord 24 results in a longer fatigue life of the cord 24 due to a cushioning effect of the soft core 32. Further, the problem of disproportionate center wire 28 or strand 30 loading is avoided since the core 32 is non load-bearing and does not contribute to the breaking strength of the cord 24. Further, if the core 32 becomes discontinuous, it does not decrease the breaking strength of the cord 24 as long as sufficient core 32 remains to enable the wires 28 to maintain the cross-sectional shape of the cord 24. Further, the core 32 has a lower bending stress relative to its fatigue strength when compared to the wires 28. Further, use of the soft core 32 allows for a greater variety of cost-effective, geometrically stable cord 24 and/or strand 30 arrangements compared to constructions not utilizing a non load-bearing core 32. Because the core 32 is non load-bearing, the size of the core 32 can be changed to accommodate a wide variety of wire 28 arrangements around the core 32, without the core 32 size contributing to determinations of breaking strength of the cord 24 or fatigue life of the cord 24.

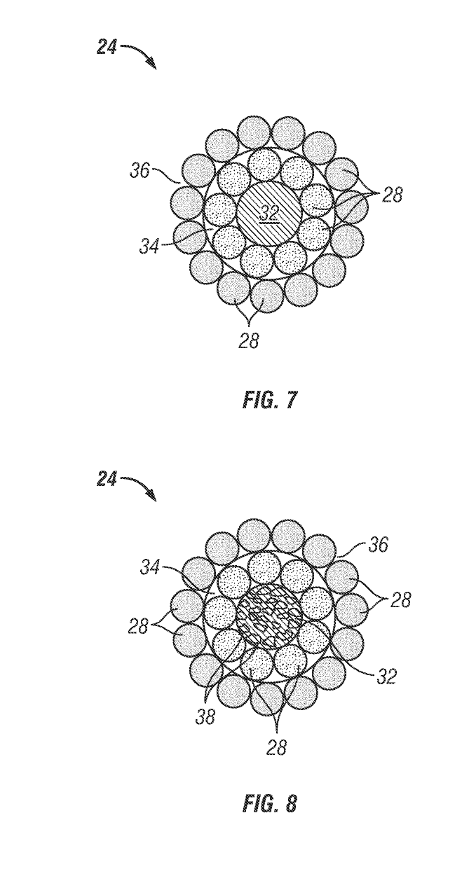

Additional exemplary constructions will now be described with reference to FIGS. 7-11. Shown in FIGS. 7 and 8 are cords 24 constructed of a non load-bearing core 32 surrounded by an inner ring 34 of 9 wires 28 surrounded by an outer ring 36 of 15 wires 28. This is referred to as a 0+9+15 arrangement. Due to the size of the core 32 and construction of the cord (e.g. using different lay lengths and/or opposite twisting of the inner ring 34 and outer ring 36 of wires 28), none of the wires 28 of the outer ring 36 move into a position within the inner ring 34. As shown in FIG. 7, the core 32 may be a single piece core 32, or as shown in FIG. 8, the core 32 may be formed of multiple core elements 38.

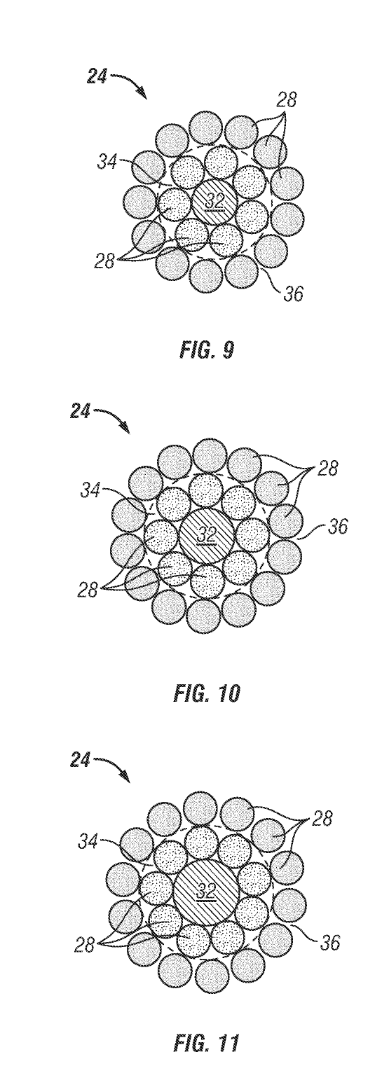

Another exemplary construction is shown in FIG. 9. In the embodiment shown, the core 32 and wires 28 are sized to accommodate an inner ring 34 of seven wires 28 surrounded by an outer ring 36 of 13 wires 28, a 0+7+13 arrangement. In the embodiment of FIG. 10, the core 32 and wires 28 are sized to accommodate an inner ring 34 of eight wires 28 surrounded by an outer ring 36 of 14 wires 28, a 0+8+14 arrangement. Similar to the embodiments described above, due to the size of the core 32 and construction of the cord (e.g. using different lay lengths and/or opposite twisting of the inner ring 34 and outer ring 36 of wires 28), none of the wires 28 of the outer ring 36 move into a position within the inner ring 34. Further, the core 32 may be a single piece core 32, or may be formed of multiple core elements 38.

Another exemplary embodiment is shown in FIG. 11. In this embodiment, the core 32 and wires 28 are sized to accommodate an inner ring 34 of nine wires 28 surrounded by an outer ring 36 of 14 wires 28, resulting in a 0+9+14 arrangement. In this arrangement, the wires 28 of the outer ring 36 are spaced for increased penetration of jacket 26 material during construction of the belt 16.

In exemplary embodiments, to allow for constructions such as described above, it is desired that the wires 28 forming the cords 24 have a similar (not necessarily identical diameter). For the purposes of this application, the phrase similar diameters means that the diameter of each wire 28 can vary up to approximately +/−10% from a mean wire diameter.

The wires 28 used in the cords 24 could be made of any suitable material that enables the cords 24 to meet the requirements of the elevator system 10. For example, the wires 28 could be formed of drawn steel. Further, the wires 28 may be additionally coated with a material that is dissimilar to the base material, to reduce or prevent corrosion, wear, and/or fretting or the like (such as zinc, brass, or a nonmetallic material), and/or to promote retention and/or interaction between the jacket material and the cord surface (such as an organic adhesive, an epoxy, or a polyurethane).

Regardless of the construction used, the twisting together of the wires 28 and/or strands 30 to form the cord 24 can contribute to the aforementioned geometric stability of the cord 24 and provide other benefits to the cord 24. The manner (and variation) of twisting has various possibilities. For example, a strand 30 or cord 24 having multiple rings of wires 28 could have the wires 28 in each of the multiple rings twisted in the same direction (referred to as a parallel lay) or have the wires 28 in one of the multiple rings twist in the opposite direction than the wire 28 in another of the multiple rings (referred to as a cross lay). Also, a cord 24 having multiple strands 30a could use strands 30a having the same twist/lay or a different twist/lay. In addition to the possible lays within a cord 24, the belt 16 could include multiple cords 24 that are twisted differently. For example, the belt 16 could have one or more cords 24 with wires 28 and/or strands 30a in a right hand lay and one or more cords 24 with wires 28 and/or strands 30a in a left hand lay. Additionally, the winding or closing operation could occur in a single step or occur in sequential steps. Further, in some embodiments, the cord 24 may be formed without twisting together of the wires 28 and/or strands 30.

Although not described above, the various cord arrangements described above could alternatively include one or more filler wires. Filler wires generally are smaller than the primary wires in the cord and carry little, if any, of the tensile load of the cord (e.g. carry less than about 12% of the mean tensile load of the primary wires).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A belt for suspending and/or driving an elevator car, comprising:
a plurality of wires arranged into one or more cords; and
a jacket substantially retaining the one or more cords;
wherein at least one of the one or more cords includes a plurality of wires arranged around at least one non load-bearing core.

2. The belt of claim 1, wherein at least some of the plurality of wires are arranged in a plurality of strands, and the plurality of strands are arranged into the one or more cords.

3. The belt of claim 2, wherein at least one of the plurality of strands includes the at least one non load-bearing core.

4. The belt of claim 2, wherein all of the plurality of strands include the at least one non load-bearing core.

5. The belt of claim 2, wherein the plurality of strands in at least one of the one or more cords comprise a plurality of outer strands arranged about one or more center strands.

6. The belt of claim 5, wherein the one or more center strands include the at least one non load-bearing core.

7. The belt of claim 1, wherein the at least one non load-bearing core is formed from an elastomeric material.

8. The belt of claim 1, wherein the at least one non load-bearing core is a single unitary element.

9. The belt of claim 1, wherein the at least one non load-bearing core is a plurality of elements.

10. The belt of claim 1, wherein the plurality of wires in the one or more cords are arranged in a geometrically stable arrangement.

11. The belt of claim 1, wherein at least one of the one or more cords comprises the at least one non load-bearing core surrounded by an inner ring of wires surrounded by an outer ring of wires.

12. An elevator system comprising:
an elevator car;
one or more sheaves; and
one or more belts operably connected to the car and interactive with the one or more sheaves for suspending and/or driving the elevator car, each belt of the one or more belts including:
a plurality of wires arranged into one or more cords; and
a jacket substantially retaining the one or more cords;
wherein at least one of the one or more cords includes a plurality of wires arranged around at least one non load-bearing core.

13. The elevator system of claim 12, wherein at least some of the plurality of wires are arranged in a plurality of strands, and the plurality of strands are arranged into the one or more cords.

14. The elevator system of claim 13, wherein at least one of the plurality of strands includes the at least one non load-bearing core.

15. The elevator system of claim 13, wherein all of the plurality of strands include the at least one non load-bearing core.

16. The elevator system of claim 13, wherein the plurality of strands in at least one of the one or more cords comprise a plurality of outer strands arranged about one or more center strands.

17. The elevator system of claim 16, wherein the one or more center strands include the at least one non load-bearing core.

18. The elevator system of claim 12, wherein the at least one non load-bearing core is formed from an elastomeric material.

19. The elevator system of claim 12, wherein the at least one non load-bearing core is a single unitary element.

20. The elevator system of claim 12, wherein the at least one non load-bearing core is a plurality of elements.

21. The elevator system of claim 12, wherein the plurality of wires in the one or more cords are arranged in a geometrically stable arrangement.

22. The elevator system of claim 12, wherein at least one of the one or more cords comprises the at least one non load-bearing core surrounded by an inner ring of wires surrounded by an outer ring of wires.

23. A cord for use in an elevator suspending and/or driving belt, comprising:
at least one non load-bearing core; and
a plurality of wires arranged around the non load-bearing core.

24. The cord of claim 23, wherein at least some of the plurality of wires are arranged in a plurality of strands.

25. The cord of claim 24, wherein at least one of the plurality of strands includes the at least one non load-bearing core.

26. The cord of claim 24, wherein all of the plurality of strands include the non load-bearing core.

27. The cord of claim 24, wherein the plurality of strands comprise a plurality of outer strands arranged about one or more center strands.

28. The cord of claim 27, wherein the one or more center strands include the at least one non load-bearing core.

29. The cord of claim 22, wherein the at least one non load-bearing core is formed from an elastomeric material.

30. The cord of claim 23, wherein the at least one non load-bearing core is a single unitary element.

31. The cord of claim 23, wherein the at least one non load-bearing core is a plurality of elements.

32. The cord of claim 23, wherein the plurality of wires are arranged in a geometrically stable arrangement.

33. The cord of claim 23, wherein the plurality of wires comprise an inner ring of wires surrounding the at least one non load-bearing core, and an outer ring of wires surrounding the inner ring of wires.
